(19) United States
(12) Patent Application Publication
(10) Pub. No.: US 2024/0218214 A1
(43) Pub. Date: Jul. 4, 2024

(54) SACRIFICIAL GLUE COMPOSITION

(71) Applicant: PANCOLOUR INK CO., LTD., Taoyuan City (TW)

(72) Inventors: HUNG-CHIN WANG, Taoyuan City (TW); YING-HUA HUANG, Taoyuan City (TW); YU-CHING PAI, Taoyuan City (TW)

(21) Appl. No.: 18/091,406

(22) Filed: Dec. 30, 2022

(51) Int. Cl. C09J 129/04; C09J 11/06; C09J 11/08; C09J 101/04; C09J 139/06

(52) U.S. Cl. CPC C09J 129/04; C09J 11/06; C09J 11/08; C09J 101/04; C09J 139/06

(57) ABSTRACT

A sacrificial glue composition comprises: a water-soluble resin, accounting for 18-40 wt % of the sacrificial glue composition; a low melting point compound, having a melting point of 90-180° C., and accounting for 2-20 wt % of the sacrificial glue composition; a foaming agent, accounting for 20-40 wt % of the sacrificial glue composition; and a residue of solvent. By the sacrificial glue composition, the problems of subsequent poor electroplating process and poor soldering of mounting on board caused by the unclean surface of the protective glue adhered on an end surface of an electronic part can be avoided, and the process efficiency and production capacity can be improved. Further, by the sacrificial glue composition, a simple mechanical force can be used to carry out rolling brushing the end surface of the passive element in the subsequent washing process, the protective glue causing the unclean surface can be removed.

### BACKGROUND OF THE INVENTION

### 1. Field of the Invention

The present disclosure relates to a sacrificial glue composition, and in particular to a sacrificial glue composition applied to the field of manufacturing electronic parts.

### 2. Description of the Related Art

In the field of manufacturing electronic parts, adhesive sheets (adhesive tapes) are widely used to perform the lamination step of multi-layer overlapping of substrates and other layers. The adhesive sheet is required to have adhesion at room temperature, and in subsequent steps (e.g. cutting steps), it can be reduced by heating or UV irradiation, and it can be peeled off.

In recent years, by adding a foaming agent or analogues thereof to the adhesive sheet, the adhesive sheet can foam or expand to reduce the adhesion area (or contact area) with an adherend by heating, so it can be more easily peeled off (separated) from the adherend. For this reason, the adhesive sheet can be used in the field of manufacturing electronic parts to represent labels that are temporarily fixed and then will be removed.

### BRIEF SUMMARY OF THE INVENTION

However, although the traditional adhesive sheet can be applied as a label to a flat object that can be flattened with an adhesive surface, it is not suitable for a small surface with a 3D shape such as an end of a passive element.

Next, referring to FIG. 1, FIG. 1 is a schematic sectional view of a sacrificial glue composition applied to a passive element. In the field of manufacturing passive component, it is necessary to coat silver glue (silver layer) 2, sacrificial glue (sacrificial glue layer) 3 and protective glue (protective glue layer) 4 to an end of a passive element body 1 from the inside to the outside, and the protective glue 4 needs to be removed in the subsequent manufacturing process (FIG. 1 shows an example of removing the protective glue at an upper end); wherein, the sacrificial glue 3 is equivalent to the role of the traditional adhesive sheet, which is used to bond the silver glue 2 and the protective glue 4. However, if the traditional adhesive sheet is used as a sacrifice glue in the field of manufacturing passive element, because its peeling (separation) ability after heating is not enough, the protective glue (also known as protective epoxy) will cause the protective glue to stick to the end of the passive element when removing it. Therefore, the application of the traditional adhesive sheet in passive components is limited, and there is room for further improvement.

The inventors have found that by using a sacrificial glue composition having a specific composition as a sacrificial glue, it can use the heating and curing process of the protective glue, so that the low melting point compound in the sacrificial glue is melted at this time to form a liquid state, and a foaming agent is also heated to soften the shell and make the internal liquid form a gas and expand at this time, resulting in an increase in the volume of the sacrificial glue and stretching the external protective glue (thermosetting protective glue), and the effect of peeling off the protective glue is easily achieved.

Further, by the sacrificial glue composition of the present disclosure, the property that water-soluble resin is easy to solve in water can be used in the subsequent washing process, using a simple mechanical force to carry out rolling brushing a surface of the end of the passive element, the protective glue adhered to the surface to cause the unclean surface can be removed.

In order to solve the above-mentioned problem, in an aspect of the present disclosure, the sacrificial glue composition comprises: a water-soluble resin, accounting for 18-40 wt % of the sacrificial glue composition; a low melting point compound, having a melting point of 90-180° C., and accounting for 2-20 wt % of the sacrificial glue composition; a foaming agent, accounting for 20-40 wt % of the sacrificial glue composition; and a residue of solvent.

In the embodiment, the water-soluble resin is at least any one selected from the group consisting of polyvinyl alcohol (PVA), polyvinylpyrrolidone (PVP) and hydroxy cellulose.

In the embodiment, the low melting point compound is selected from the group consisting of the following: neopentyl glycol, xylitol, sorbitol, ribitol, glucose, fructose and erythritol.

In the embodiment, the foaming agent is polystyrene microspheres or acrylonitrile/methacrylonitrile/methyl methacrylate copolymer.

In the embodiment, the foaming agent has a foaming temperature of 130-200° C.

In the embodiment, the solvent is selected from the group consisting of the following: ethylene glycol, diethylene glycol monobutyl ether, propylene glycol methyl ether, ethylene glycol mono-tert-butyl ether, dipropylene glycol methyl ether, ethylene glycol monobutyl ether, 3-methoxy-3-methyl-1-butanol, polytetramethylene ether glycol, 2-methyl-1,3-propanediol, 1,4-butanediol, ethylene glycol and water.

In the embodiment, the sacrificial glue composition has a viscosity of 20-100 Kcps at 25° C.

In the embodiment, the sacrificial glue composition further comprises: a leveling agent, accounting for 0.3-3 wt % of the sacrificial glue composition.

An aspect of the present disclosure is accomplished based on the problem point of the above prior art, the objective is to provide a sacrificial glue composition having a particular composition. Also, by applying the sacrificial glue composition to the sacrificial glue in the end electrode process of the passive element, the problems of subsequent poor electroplating process and poor soldering of mounting on board caused by the unclean surface of the protective glue adhered on the end surface can be avoided, and the cost of manual visual inspection can be reduced, and the process efficiency and production capacity can be improved.

Further, by the sacrificial glue composition of the present disclosure, a simple mechanical force can be used to carry out rolling brushing a surface of the end of the passive element in the subsequent washing process, the protective glue adhered to the surface to cause the unclean surface can be removed.

### BRIEF DESCRIPTION OF THE DRAWINGS

FIG. 1 is a schematic sectional view of a sacrificial glue composition applied to a passive element.

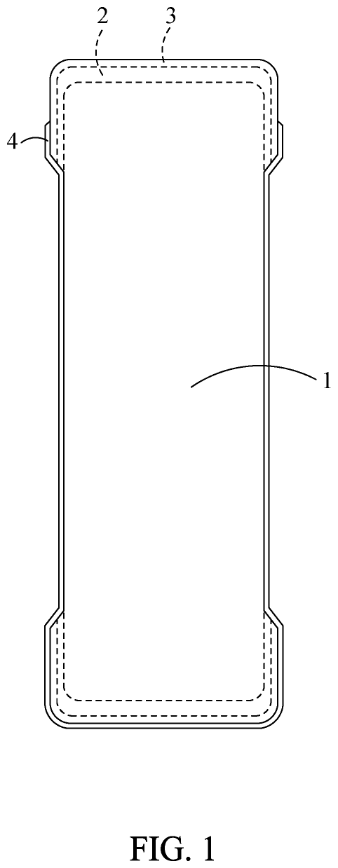

### DETAILED DESCRIPTION OF THE INVENTION

The implementation of the present disclosure is illustrated by the specific embodiments as follows, so one skilled in the art may understand other advantages and effects of the present disclosure by the contents disclosed in the specification. The present disclosure may also be implemented or applied by other embodiments, and the details in the specification may also be based on different views and applications without departing from the spirit of the present disclosure for various modifications and variations.

Unless otherwise specified herein, the term “or” used in the specification and the claims attached includes the meaning of “and/or”.

Unless otherwise specified herein, the term “A-B” used in the specification and the claims attached includes the meaning of “A or more and B or less”. For example, the term “10-40 wt %” includes the meaning of “10 wt % or more and 40 wt % or less.

### <Sacrificial Glue Composition>

The sacrificial glue composition of the present disclosure comprises: a water-soluble resin, a low melting point compound, a foaming agent and a solvent, and may further comprise a leveling agent or other ingredients as necessary. The various ingredients comprised in the sacrificial glue composition of the present disclosure are described below.

### <<Water-Soluble Resin>>

In the present disclosure, the water-soluble resin accounts for 18-40 wt % of the sacrificial glue composition. Also, the water-soluble resin may be polyvinyl alcohol (PVA), polyvinylpyrrolidone (PVP), hydroxy cellulose, etc., and there is no special restriction.

In addition, when the content of water-soluble resin is less than 18 wt %, viscosity of the sacrificial glue composition is too low (less than 20 Kcps at 25° C.), and powder in the sacrificial glue layer formed is easy to cause lamination; also, when the content of water-soluble resin is greater than 40 wt %, the viscosity of the sacrificial glue composition is too high (greater than 100 Kcps at 25° C.) to be easily handled. In other words, the viscosity of the aforementioned sacrificial glue composition at 25° C. is preferably 20-100 Kcps.

### <<Low Melting Point Compound>>

In the present disclosure, the low melting point compound accounts for 2-20 wt % of the sacrificial glue composition. Also, melting point of the aforementioned low melting point compound is 90-180° C., and preferably 90-160° C., and the aforementioned low melting point compound may be low melting point polyol or low melting point carbohydrate, and there is no special restriction. Specifically, the aforementioned low melting point compound is selected from the group consisting of the following: neopentyl glycol (melting point 120° C.), xylitol (92° C.), sorbitol (95 ºC), ribitol (102° C.), glucose (146° C.), fructose (103° C.) and erythritol (120° C.).

In addition, if the content of low melting point compound is less than 2 wt %, a liquid melted during subsequent heating is insufficient, resulting in the inability to stretch the protective film; if the content of low melting point compound is greater than 20 wt %, a solid is easy to precipitate, and the sacrificial glue layer formed is uneven.

### <<Foaming Agent>>

In the present disclosure, the foaming agent accounts for 20-40 wt % of the sacrificial glue composition. Also, the aforementioned foaming agent may be expansion balls (also known as foamable microspheres). Foamable microspheres are tiny spherical plastic particles consisting of a polymer shell and a gas encapsulated therein. When heated, an internal pressure of the gas increases and the polymer shell softens at the same time, resulting in a large increase in the volume of microspheres. Specifically, the aforementioned foaming agent may be polystyrene microspheres, acrylonitrile/methacrylonitrile/methyl methacrylate copolymer (made by Nouryon, Expancel® microspheres, CAS registration number 38742-70-0), etc., and there is no special restriction. Moreover, a foaming temperature of the aforementioned foaming agent is preferably 130-200° C., if the foaming temperature is less than 130° C., the expansion of the foaming agent is too early that is easy to make the slurry unstable; If the foaming temperature is greater than 200° C., the resin will be damaged and coking, resulting in difficulty in washing.

In addition, if the content of the foaming agent is less than 20 wt %, the volume expansion during subsequent heating is insufficient, resulting in the inability to stretch the protective film; if the content of the foaming agent is greater than 40 wt %, the sacrificial glue layer formed will have surface crusting.

### <<Solvent>>

In the present disclosure, the solvent is a residual ingredient of the sacrificial glue composition, which may be alcohol or alcohol ether. Generally speaking, the solvent accounts for about 20-60 wt % of the sacrificial glue composition, as long as it can fully dissolve the ingredients in the sacrificial glue composition, and there is no special restriction. Also, the foregoing solvent may be selected from the group consisting of the following: ethylene glycol, diethylene glycol monobutyl ether, propylene glycol methyl ether, ethylene glycol mono-tert-butyl ether, dipropylene glycol methyl ether, ethylene glycol monobutyl ether, 3-methoxy-3-methyl-1-butanol, polytetramethylene ether glycol, 2-methyl-1,3-propanediol, 1,4-butanediol, ethylene glycol and water.

### <<Leveling Agent>>

Without affecting the effect that the present disclosure intends to achieve, the sacrificial glue composition of the present disclosure may further be added with a leveling agent as needed to promote the sacrificial glue composition to form a flat, smooth, uniform sacrificial glue layer during a drying and film-forming process. Also, the aforementioned leveling agent preferably accounts for 0.3-3 wt % of the sacrificial glue composition. In addition, the leveling agent may be BYK-302 manufactured by BYK, and there is no special restriction.

### <<Other Ingredients>>

In terms of other ingredients, it can be adapted to the needs, without affecting the effect that the sacrificial glue composition of the present disclosure can achieve, other ingredients such as known defoamers, inorganic filler materials and pigments can be added. In addition, the amount of other ingredients may be 0-2 wt % of the sacrificial glue composition.

### EMBODIMENTS

Although the present disclosure is specifically illustrated by various embodiments and comparative examples, the present disclosure is not limited to the embodiments and comparative examples.

### Comparative Examples 1-7 and Embodiments 1-7

Referring to the composition of Table 1-Table 4 below, each ingredient is added to the container and carefully stirred and mixed to form sacrificial glue compositions of comparative examples 1-7 and embodiments 1-17. Also, “number %” in Table 1-Table 4 refers to the weight percentage of each ingredient.

TABLE 1

| Ingredient | | CE1 | CE2 | CE3 | CE4 | CE5 | CE6 | CE7 |
|---|---|---|---|---|---|---|---|---|
| Acrylic resin | | 18.0% | — | — | — | — | — | 18.0% |
| Polyvinylpyrrolidone | | — | 18.0% | 18.0% | 40.0% | 40.0% | 35.0% | — |
| (made by zhong-wei chemical company) | | | | | | | | |
| Foaming | made by Nouryon, | 24.0% | 24.0% | 40.0% | 24.0% | — | 35.0% | 24.0% |
| agent | Expancel 551 DU40 | | | | | | | |
| | made by Nouryon, | — | — | — | — | 24.0% | — | — |
| | Expancel 461 DU20 | | | | | | | |
| Low | pentylene glycol | — | — | — | — | — | — | 2.0% |
| melting | (CAS#126-30-7) | | | | | | | |
| point | xylitol | — | — | — | — | — | — | — |
| compound | (CAS#50-70-4) | | | | | | | |
| | sorbitol | — | — | — | — | — | — | — |
| | (CAS#87-99-0) | | | | | | | |

| | | | | | | | |
|---|---|---|---|---|---|---|---|
| Leveling agent (BYK-302) | 0.3% | 0.3% | 0.3% | 0.3% | 0.3% | 0.3% | 0.3% |
| Ethylene glycol/diethylene | 1:1 | 1:1 | 1:1 | 1:1 | 1:1 | 1:1 | 1:1 |
| glycol monobutyl ether | (residual | (residual | (residual | (residual | (residual | (residual | (residual |
| (CAS#107-21-1/CAS#111-76-2) | amount) | amount) | amount) | amount) | amount) | amount) | amount) |

TABLE 2

| Ingredient | | E1 | E2 | E3 | E4 | E5 | E6 | E7 |
|---|---|---|---|---|---|---|---|---|
| Acrylic resin | | — | — | — | — | — | — | — |
| Polyvinylpyrrolidone | | 18.0% | 18.0% | 18.0% | 18.0% | 18.0% | 18.0% | 18.0% |
| (made by zhong-wei chemical company) | | | | | | | | |
| Foaming | made by Nouryon, | 24.0% | 40.0% | 24.0% | 24.0% | 24.0% | 40.0% | 40.0% |
| agent | Expancel 551 DU40 | | | | | | | |
| | made by Nouryon, | — | — | — | — | — | — | — |
| | Expancel 461 DU20 | | | | | | | |
| Low | pentylene glycol | 2.0% | 2.0% | 10.0% | — | — | 10.0% | — |
| melting | (CAS#126-30-7) | | | | | | | |
| point | xylitol | — | — | — | — | 10.0% | — | — |
| compound | (CAS#50-70-4) | | | | | | | |
| | sorbitol | — | — | — | 10.0% | — | — | 10.0% |
| | (CAS#87-99-0) | | | | | | | |

| | | | | | | | |
|---|---|---|---|---|---|---|---|
| Leveling agent (BYK-302) | 0.3% | 0.3% | 0.3% | 0.3% | 0.3% | 0.3% | 0.3% |
| Ethylene glycol/diethylene | 1:1 | 1:1 | 1:1 | 1:1 | 1:1 | 1:1 | 1:1 |
| glycol monobutyl ether | (residual | (residual | (residual | (residual | (residual | (residual | (residual |
| (CAS#107-21-1/CAS#111-76-2) | amount) | amount) | amount) | amount) | amount) | amount) | amount) |

TABLE 3

| Ingredient | | E8 | E9 | E10 | E11 | E12 | E13 | E14 |
|---|---|---|---|---|---|---|---|---|
| Acrylic resin | | — | — | — | — | — | — | — |
| Polyvinylpyrrolidone | | 18.0% | 40.0% | 40.0% | 35.0% | 35.0% | 35.0% | 40.0% |
| (made by zhong-wei chemical company) | | | | | | | | |
| Foaming | made by Nouryon, | 40.0% | 24.0% | — | 35.0% | 35.0% | 35.0% | 24.0% |
| agent | Expancel 551 DU40 | | | | | | | |
| | made by Nouryon, | — | — | 24.0% | — | — | — | — |
| | Expancel 461 DU20 | | | | | | | |
| Low | pentylene glycol | — | 4.0% | 4.0% | 4.0 | — | — | 10.0 |
| melting | (CAS#126-30-7) | | | | | | | |
| point | xylitol | 10.0% | — | — | — | — | 4.0% | — |
| compound | (CAS#50-70-4) | | | | | | | |
| | sorbitol | — | — | — | — | 4.0 | — | — |
| | (CAS#87-99-0) | | | | | | | |

| | | | | | | | |
|---|---|---|---|---|---|---|---|
| Leveling agent (BYK-302) | 0.3% | 0.3% | 0.3% | 0.3% | 0.3% | 0.3% | 0.3% |
| Ethylene glycol/diethylene | 1:1 | 1:1 | 1:1 | 1:1 | 1:1 | 1:1 | 1:1 |
| glycol monobutyl ether | (residual | (residual | (residual | (residual | (residual | (residual | (residual |
| (CAS#107-21-1/CAS#111-76-2) | amount) | amount) | amount) | amount) | amount) | amount) | amount) |

TABLE 4

| Ingredient | | E15 | E16 | E17 |
|---|---|---|---|---|
| Acrylic resin | | — | — | — |
| Polyvinylpyrrolidone | | 35.0% | 35.0% | 30.0% |
| (made by zhong-wei | | | | |
| chemical company) | | | | |
| Foaming | made by | 35.0% | 24.0% | 30.0% |
| agent | Nouryon, | | | |
| | Expancel 551 | | | |
| | DU40 | | | |
| | made by | — | — | — |
| | Nouryon, | | | |
| | Expancel 461 | | | |
| | DU20 | | | |
| Low | pentylene glycol | 10.0% | 20.0% | 20.0% |
| melting | (CAS#126-30-7) | | | |
| point | xylitol | — | — | — |
| compound | (CAS#50-70-4) | | | |
| | sorbitol | — | — | — |
| | (CAS#87-99-0) | | | |

| | | | |
|---|---|---|---|
| Leveling agent | 0.3% | 0.3% | 0.3% |
| (BYK-302) | | | |
| Ethylene | 1:1 | 1:1 | 1:1 |
| glycol/diethylene | (residual | (residual | (residual |
| glycol monobutyl ether | amount) | amount) | amount) |
| (CAS#107-21-1/ | | | |
| CAS#111-76-2) | | | |

### [Application of Sacrificial Glue Composition]

Next, the process for applying the aforementioned sacrificial glue composition to a passive element is explained.

First, the finished body feedstock of passive element is arranged and leveled, and then two ends of the passive element are coated with silver glue. Next, the passive element is blanked, hardened at about 210° C., and then fed, moreover, a slurry of the sacrificial glue composition of each the above comparative example and embodiment is coated on the silver glue of the passive element. Afterwards, the slurry of the sacrificial glue composition is dried at a temperature of 70-80° C. to form a sacrificial glue layer, and a temperature-resistant tape is pasted thereon, and then the protective glue (a centrifuge can be used to reduce the thickness as needed) is coated on the temperature-resistant tape, furthermore, the temperature is raised to 180-200° C. through a tunnel furnace or oven to solidify the protective glue into a protective glue layer.

In the process of heating to 180-200° C., the low melting point compound in the dried sacrificial glue composition will melt into a liquid state because the temperature is raised to exceed its melting point, and because the temperature is raised to exceed the foaming temperature of the foaming agent (expansion ball) and makes it expand by heating, the volume of the sacrificial glue layer can be expanded more easily, and the protective glue layer coated on the sacrificial glue layer is stretched out to crack. The sacrificial glue composition of each embodiment can be subsequently performed by a washing process to remove the sacrificial glue layer, and then the passive element plated with a nickel-tin layer can be obtained by electroplating process. After that, solder paste can be printed on a circuit board, and the plated passive element can be soldered to the circuit board through a reflow oven.

Herein, the inventors determined the expansion effect, peelability by water washing, integrity of electroplating film and solder filleting property of mounting on board in the process for applying the sacrificial glue composition to the passive element. The results are summarized in Table 5.

### <Expansion Effect>

By observing a cracking manner of the protective glue, the expansion effect of the sacrificial glue layer in the process of heating to 180-200° C. was evaluated. When the protective glue is observed to form an off-white color caused by expansion and cracking, it is recorded as O, and when the original black is maintained, it is recorded as X, where O is an acceptable result.

### <Peelability by Water Washing>

By water rinsing method, the peelability by water washing of the sacrificial glue layer in the water washing process was evaluated. When the sacrificial glue is almost completely peeled off after water rinsing, it is recorded as O, and when an area of the sacrificial glue that has not peeled off is higher than 10%, it is recorded as X, where O is an acceptable result.

### <Integrity of Electroplating Film>

By metal plating method, the integrity of the electroplating film of a nickel-tin layer in the electroplating process was evaluated. When the electrode can completely cover the metal layer, it is recorded as O, and when the electrode coverage is incomplete or there is a case where plating is not possible, it is recorded as X, where O is an acceptable result.

### <Solder Filleting Property of Mounting on Board>

By reflow soldering method of mounting on board, the solder filleting property of mounting on board that the solder paste on the circuit board climbs on the passive element was evaluated. When the solder climbs above ½ of a height of the element, it is recorded as O. and when the solder climbs to less than ½ of the height of the element, it is recorded as X, where O is an acceptable result.

TABLE 5

| Comparative | | | | Solder filleting |
|---|---|---|---|---|
| examples and | | Peelability | Integrity of | property of |
| embodiments/ | Expansion | by water | electroplating | mounting on |
| Evaluation | effect | washing | film | board |
| CE1 | X | X | — | — |
| CE2 | X | X | — | — |
| CE3 | X | X | — | — |
| CE4 | X | X | — | — |
| CE5 | X | X | — | — |
| CE6 | X | X | — | — |
| CE7 | ◯ | X | — | — |
| E1 | ◯ | ◯ | ◯ | ◯ |
| E2 | ◯ | ◯ | ◯ | ◯ |
| E3 | ◯ | ◯ | ◯ | ◯ |
| E4 | ◯ | ◯ | ◯ | ◯ |
| E5 | ◯ | ◯ | ◯ | ◯ |
| E6 | ◯ | ◯ | ◯ | ◯ |
| E7 | ◯ | ◯ | ◯ | ◯ |
| E8 | ◯ | ◯ | ◯ | ◯ |
| E9 | ◯ | ◯ | ◯ | ◯ |
| E10 | ◯ | ◯ | ◯ | ◯ |
| E11 | ◯ | ◯ | ◯ | ◯ |
| E12 | ◯ | ◯ | ◯ | ◯ |
| E13 | ◯ | ◯ | ◯ | ◯ |
| E14 | ◯ | ◯ | ◯ | ◯ |
| E15 | ◯ | ◯ | ◯ | ◯ |
| E16 | ◯ | ◯ | ◯ | ◯ |
| E17 | ◯ | ◯ | ◯ | ◯ |

First, it can be seen from Table 5 that because acrylic resin is used in comparative example 1, no water-soluble resin is used, and no low melting point compound is added, the expansion effect and the peelability by water washing are not preferable. Secondly, although water-soluble resin (polyvinylpyrrolidone) is used in comparative examples 2-6, because no low melting point compound is added, the expansion effect of the sacrificial glue layer formed is not preferable, and the peelability by water washing is also not preferable. Further, although comparative example 7 has a preferable expansion effect because of the addition of low melting point compound, because it uses acrylic resin, no water-soluble resin is not used, and the peelability by water washing is not preferable. In addition, because the expansion effect and peelability by water washing of comparative examples 1-7 are not preferable, subsequent tests of the integrity of electroplating film and the solder filleting property of mounting on board cannot be carried out.

Next, it can be seen from the above Table 5 that because embodiments 1-17 use the sacrificial glue composition of the present disclosure, the expansion effect and the peelability by water washing of the sacrificial glue layer formed thereof are preferable, and the subsequent integrity of electroplating film and the solder filleting property of mounting on board are also preferable.

The present invention is not limited to the above embodiments, various changes may be made within the scope of claims, and embodiments obtained by the appropriate combination of the technical means disclosed in the different embodiments are also included within the technical scope of the present invention.

What is claimed is:

1. A sacrificial glue composition, comprising:
a water-soluble resin, accounting for 18-40 wt % of the sacrificial glue composition;
a low melting point compound, having a melting point of 90-180° C., and accounting for 2-20 wt % of the sacrificial glue composition;
a foaming agent, accounting for 20-40 wt % of the sacrificial glue composition; and
a residue of solvent.

2. The sacrificial glue composition according to claim 1, wherein the water-soluble resin is at least any one selected from the group consisting of polyvinyl alcohol (PVA), polyvinylpyrrolidone (PVP) and hydroxy cellulose.

3. The sacrificial glue composition according to claim 1, wherein the low melting point compound is selected from the group consisting of the following: neopentyl glycol, xylitol, sorbitol, ribitol, glucose, fructose and erythritol.

4. The sacrificial glue composition according to claim 1, wherein the foaming agent is polystyrene microspheres or acrylonitrile/methacrylonitrile/methyl methacrylate copolymer.

5. The sacrificial glue composition according to claim 4, wherein the foaming agent has a foaming temperature of 130-200° C.

6. The sacrificial glue composition according to claim 1, wherein the solvent is selected from the group consisting of the following: ethylene glycol, diethylene glycol monobutyl ether, propylene glycol methyl ether, ethylene glycol mono-tert-butyl ether, dipropylene glycol methyl ether, ethylene glycol monobutyl ether, 3-methoxy-3-methyl-1-butanol, polytetramethylene ether glycol, 2-methyl-1,3-propanediol, 1,4-butanediol, and water.

7. The sacrificial glue composition according to claim 1, wherein the sacrificial glue composition has a viscosity of 20-100 Kcps at 25° C.

8. The sacrificial glue composition according to claim 1, wherein the sacrificial glue composition further comprises: a leveling agent, accounting for 0.3-3 wt % of the sacrificial glue composition.

9. The sacrificial glue composition according to claim 7, wherein the sacrificial glue composition further comprises: a leveling agent, accounting for 0.3-3 wt % of the sacrificial glue composition.
